(19) United States
(12) Patent Application Publication
(10) Pub. No.: US 2025/0317382 A1
(43) Pub. Date: Oct. 9, 2025

(54) COMMUNICATION APPARATUS, CONTROL METHOD, AND STORAGE MEDIUM

(71) Applicant: CANON KABUSHIKI KAISHA, Tokyo (JP)

(72) Inventor: KOHTARO KOIKE, Kanagawa (JP)

(21) Appl. No.: 19/170,677

(22) Filed: Apr. 4, 2025

(30) Foreign Application Priority Data
Apr. 9, 2024 (JP) 2024-062764

(51) Int. Cl. H04L 45/24; H04L 1/1867; H04L 47/62; H04L 69/14

(52) U.S. Cl. CPC H04L 45/24; H04L 1/1893; H04L 47/62; H04L 69/14

(57) ABSTRACT

A communication apparatus establishes a plurality of links with a different communication apparatus by a Multi-Link function, sets TID-to-Link Mapping which allocates Traffic Identifiers (TIDs) to the established links, determines whether a link state of each of one or more links with the TIDs allocated thereto is a link state in which a communication quality needed for communicating a specific type of data corresponding to a specific category has been ensured, and, in a case where it is determined that one or more links to which TIDs in the specific category are mapped are not in the link state in which the communication quality has been ensured, resets the TID-to-Link Mapping in such a manner that the specific type of data is not transmitted via the one or more links determined not to be in the link state in which the communication quality has ensured.

### BACKGROUND

### Field of the Disclosure

Aspects of the present disclosure generally relate to a communication apparatus which communicates data, a control method for the communication apparatus, and a storage medium.

### Description of the Related Art

As discussed in U.S. Patent Application Publication No. US 2023/0049620, Multi-Link is one of new functions of the standard IEEE 802.11be (also referred to as “Wi-Fi 7”).

This function is to establish a plurality of links by causing a plurality of interfaces mounted in equipment called a multi-link device (MLD) to cooperate and collaborate with each other.

In each of the plurality of links, the order of priority for transmitting frames is preliminarily defined with use of an identifier that is called a Traffic ID (TID) and is used for classifying packets.

TIDs are classified into four categories, i.e., Voice, Video, Best-Effort, and Background.

Voice, Video, Best-Effort, and Background to be mentioned in the following description mean categories of TIDs.

Then, a plurality of links is established by joining TIDs and link IDs at the time of link establishment (called “TID-to-Link Mapping).

This brings about expectations for an increase in throughput, an improvement in frequency usage efficiency, and an improvement in communication latency.

### SUMMARY

According to an aspect of the present disclosure, a communication apparatus includes at least one memory that stores a set of instructions, and at least one processor that executes the instructions, the instructions, when executed, causing the communication apparatus to perform operations including performing control to establish a plurality of links with a different communication apparatus by a Multi-Link function, setting TID-to-Link Mapping which allocates Traffic Identifiers (TIDs) to the established plurality of links, performing determination processing for determining whether a link state of each of one or more links with the TIDs allocated thereto is a link state in which a communication quality needed for communicating a specific type of data corresponding to a specific category has been ensured, and, in a case where, as a result of the determination processing, it is determined that one or more links to which TIDs in the specific category are mapped are not in the link state in which the communication quality needed for communicating the specific type of data has been ensured, resetting the TID-to-Link Mapping in such a manner that the specific type of data is not transmitted via the one or more links determined not to be in the link state in which the communication quality has been ensured.

Further features of various embodiments will become apparent from the following description of exemplary embodiments with reference to the attached drawings.

### BRIEF DESCRIPTION OF THE DRAWINGS

FIG. 1 is a diagram illustrating a configuration example of a system according to a first exemplary embodiment.

FIG. 2 is a block diagram illustrating a functional configuration example of an image capturing apparatus according to the first exemplary embodiment.

FIG. 3 is a block diagram illustrating a hardware configuration example of each of the image capturing apparatus and information equipment according to the first exemplary embodiment.

FIG. 4 is a schematic diagram of Traffic IDs (TIDs) and access categories according to the first exemplary embodiment.

FIG. 5 is a diagram illustrating an allocation example of TID-to-Link Mapping indicating how categories of TIDs are allocated to respective links according to the first exemplary embodiment.

FIGS. 6A and 6B are sequence diagrams illustrating the flow of operations for performing reallocation of TID-to-Link Mapping according to the first exemplary embodiment.

FIG. 7 is a diagram illustrating an example of an information element for exchanging information about TID-to-Link Mapping according to the first exemplary embodiment.

FIG. 8 is a flowchart illustrating processing for performing reallocation of TID-to-Link Mapping according to the first exemplary embodiment.

FIGS. 9A and 9B are diagrams used to explain an example of reallocation of TID-to-Link Mapping according to the first exemplary embodiment.

FIGS. 10A and 10B are diagrams illustrating an example of reallocation of TID-to-Link Mapping to be performed in a case where there are two links with a good communication state in Example 1 according to a second exemplary embodiment.

FIGS. 11A and 11B are diagrams illustrating an example of reallocation of TID-to-Link Mapping to be performed in a case where there is only one link with a good communication state in Example 2 according to the second exemplary embodiment.

### DESCRIPTION OF THE EMBODIMENTS

Various exemplary embodiments, features, and aspects of the disclosure will be described in detail below with reference to the drawings.

However, the following exemplary embodiments are not intended to limit the claims, and, while a plurality of features is described in each exemplary embodiment, not all of these features are necessarily essential for every embodiment and some or all of the features can be optionally combined.

Furthermore, throughout the whole description of the exemplary embodiments, the same constituent elements are assigned the respective same reference numerals or characters, and any duplicated description thereof may be omitted in some cases.

There can conceivable be a case where, if retransmission becomes increasingly performed due to, for example, a communication environment in part of a link established in a multi-link device (MLD), it becomes difficult to transmit data corresponding to the currently set category of Traffic IDs (TIDs). For example, the category of TIDs of a link via which streaming data is being transmitted generally falls into the classification of the Video category. Here, if the number of times of retransmission for the Video category increases, it may become impossible for the opposite equipment side to smoothly reproduce the streaming data. In that case, the link may become unable to play the role of a communication link for transmitting data for the Video category, thus resulting in reduced efficiency, and, therefore, the following first exemplary embodiment provides a system for efficiently using a link depending on a communication situation. The first exemplary embodiment is specifically described as follows.

### <Configuration of System>

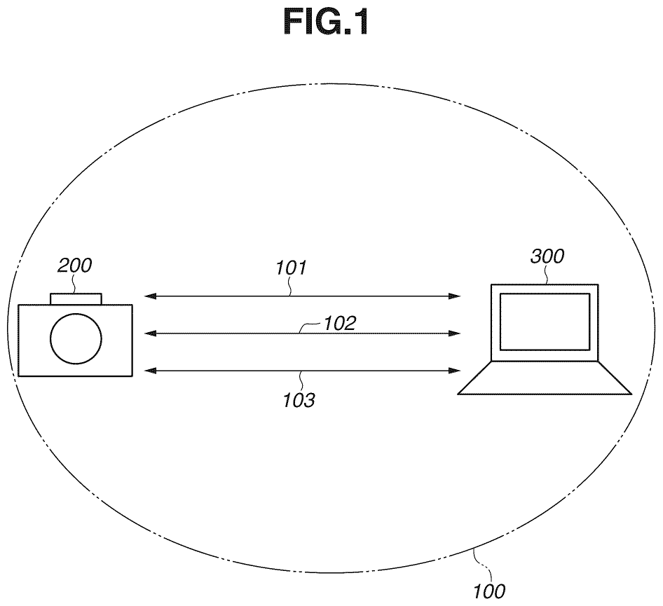

FIG. 1 is a diagram illustrating a configuration example of a system according to the first exemplary embodiment.

As illustrated in FIG. 1, in the first exemplary embodiment, the system includes an image capturing apparatus 200 and information equipment 300, and is configured in such a manner that the image capturing apparatus 200 and the information equipment 300 perform communications using the respective links (a link 101, a link 102, and a link 103) within a network 100.

Furthermore, the image capturing apparatus 200 is an example of an information communication terminal according to an aspect of the present disclosure, and the information equipment 300 is an example of opposite equipment according to an aspect of the present disclosure.

In the first exemplary embodiment, it is assumed that the image capturing apparatus 200 generates streaming data and transmits the streaming data to the information equipment 300.

The image capturing apparatus 200 and the information equipment 300 are able to perform a wireless communication conforming to the IEEE 802.11be (EHT) standard.

Furthermore, IEEE is an abbreviation for Institute of Electrical and Electronics Engineers.

Moreover, EHT is an abbreviation for Extremely High Throughput.

In the first exemplary embodiment, the image capturing apparatus 200 is caused to operate as an Access Point (also referred to as “AP”) and the information equipment 300 is caused to operate as a Station (also referred to as “STA”).

However, the first exemplary embodiment is not limited to this, and an apparatus or equipment to be caused to operate as an AP or an STA can be, for example, a smartphone, a tablet, a personal computer (PC), or a video camera.

The image capturing apparatus 200 and the information equipment 300 are configured to be interconnected via, for example, three links (the link 101, the link 102, and the link 103).

While examples of frequency bands to be used include a 2.4 gigahertz (GHz) band, a 5 GHz band, and 6 GHz band, an entirely different frequency band such as a 60 GHz band can be used.

Moreover, such a plurality of links can be established with use of respective different frequency bands or can be established with use of an identical frequency band.

Furthermore, in a case where an identical frequency band is used, respective different channels are caused to be used for the plurality of links.

Moreover, the image capturing apparatus 200 and the information equipment 300 are able to perform communications with use of bandwidths of 20 megahertz (MHz), 40 MHz, 80 MHz, 160 MHz, and 320 MHz.

Furthermore, the bandwidths which, for example, the image capturing apparatus 200 and the information equipment 300 use are not limited to the same bandwidth, but respective different bandwidths, such as 240 MHz and 4 MHz, can be used.

### <Functional Configuration of Image Capturing Apparatus 200>

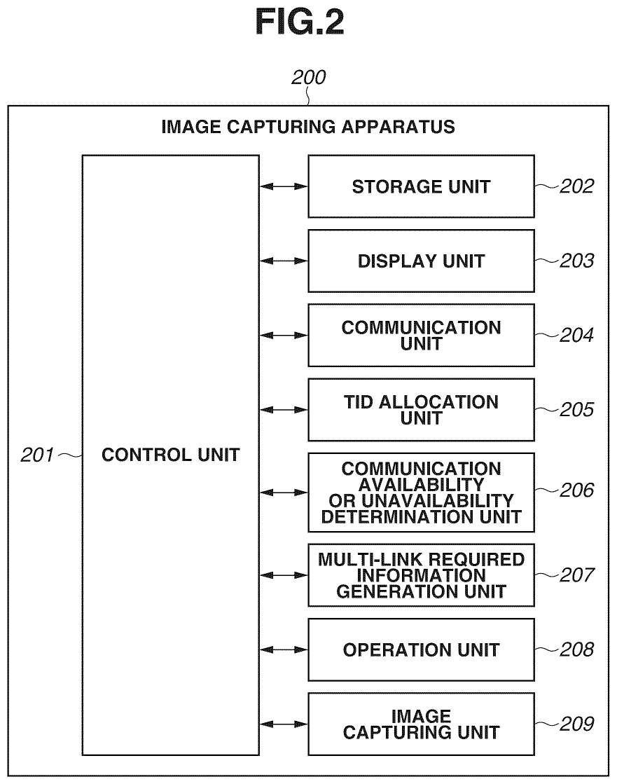

FIG. 2 is a block diagram illustrating a functional configuration example of the image capturing apparatus 200 according to the first exemplary embodiment.

While the functional configuration of the image capturing apparatus 200 in the first exemplary embodiment is described with reference to FIG. 2, the following configuration of functional blocks to be described below is merely an example.

Thus, some of the functional blocks to be described below (in some cases, all of them) can be replaced with other functional blocks serving similar functions, some of the functional blocks can be omitted, or a further functional block can be added.

Moreover, one functional block to be described below can be divided into a plurality of functional blocks, or a plurality of functional blocks can be integrated into one functional block.

Furthermore, while the information equipment 300 also has a configuration similar to that of the image capturing apparatus 200, this point is described below.

The image capturing apparatus 200 includes a control unit 201, a storage unit 202, a display unit 203, a communication unit 204, a TID allocation unit 205, a communication availability or unavailability determination unit 206, a Multi-Link required information generation unit 207, an operation unit 208, and an image capturing unit 209.

### <Control Unit 201>

The control unit 201 controls each unit of the image capturing apparatus 200 according to input signals or programs described below.

Moreover, the control unit 201 also performs control concerning a multi-link device (MLD).

Furthermore, instead of the control unit 201 controlling the entire image capturing apparatus 200, a plurality of pieces of hardware can share processing operations to control the entire image capturing apparatus 200.

### <Storage Unit 202>

The storage unit 202 stores, for example, a control program which the control unit 201 executes, information concerning communications, Traffic IDs (also referred to “TIDs”), and link IDs.

Various operations described below are performed by the control unit 201 executing the control program stored in the storage unit 202.

### <Display Unit 203>

The display unit 203 performs displaying of a viewfinder image for use in image capturing, displaying of image data obtained by image capturing, and displaying of characters used for dialogical operations.

Besides this, the display unit 203 performs lighting, blinking, and turn-off displaying using, for example, lamps.

### <Communication Unit 204>

The communication unit 204 is an example of a plurality-of-links establishment unit which establishes a plurality of links according to an aspect of the present disclosure.

The communication unit 204 is an interface for performing, for example, Wi-Fi® communication with an external apparatus, such as the information equipment 300, and is compatible with the IEEE 802.11be standard.

Thus, the communication unit 204 is configured to be able to perform communications for a wireless frame conforming to the IEEE 802.11be standard.

A wireless frame which is communicated by the IEEE 802.11be standard is also referred to as “EHT PPDU”.

PPDU is an abbreviation for Physical Layer Protocol Data Unit.

Moreover, the information equipment 300 or the image capturing apparatus 200 in the first exemplary embodiment can be compatible with the IEEE 802.11bn standard, which is a successor standard of the IEEE 802.11be standard.

The IEEE 802.11bn standard, which is a successor standard of the IEEE 802.11be standard, is mainly characterized by highly reliable communication, low-latency communication, and throughput enhancement.

Moreover, in the IEEE 802.11bn standard, reducing electric power consumption in an AP is also one of the aimed objectives.

A wireless frame which is communicated by the IEEE 802.11bn standard is also referred to as “Ultra High Reliability (UHR) PPDU”.

PPDU is an abbreviation for Physical Layer Protocol Data Unit.

Furthermore, the name specified as UHR is a name provided for the sake of

convenience in light of the objective to be attained in the successor standard or the characteristic highlighted in the successor standard, and can become a different name in a state in which the formulation of the standard has been completed.

The name specified as IEEE 802.11bn also becomes a different name in a state in which the formulation of the standard has been completed.

On the other hand, it should be noted that the present specification and the accompanying claims are essentially applicable to the IEEE 802.11be standard and all of the successor standards thereof.

Additionally, the communication unit 204 can be compatible with a legacy standard which is before the IEEE 802.11be standard.

Specifically, the communication unit 204 of the image capturing apparatus 200, which is caused to operate as an AP, can be compatible with at least any one of the IEEE 802.11a, 802.11b, 802.11g, 802.11n, 802.11ac, and 802.11ax standards.

Moreover, a communication unit 304 (described below) of the information equipment 300, which is caused to operate as an STA, is also configured in the same manner as that for the communication unit 204 of the image capturing apparatus 200, which is caused to operate as an AP.

Thus, the communication unit 304 (described below) of the information equipment 300 supports communications for a wireless frame in the IEEE 802.11be standard and the IEEE 802.11bn standard, but can also be compatible with, in addition thereto, legacy standards.

Additionally, the communication unit 204 or the communication unit 304 can also be compatible with, in addition to the IEEE 802.11 series standards, other communication standards such as Bluetooth®, NFC, UWB, ZigBee, and MBOA, and, additionally, can also be compatible with a communication standard for wired communication such as a wired local area network (LAN).

UWB includes, for example, wireless Universal Serial Bus (USB), wireless 1394 ,and WiNET.

Furthermore, UWB is an abbreviation for Ultra Wide Band, MBOA is an abbreviation for Multi Band OFDM Alliance, and NFC is an abbreviation for Near Field Communication.

In the first exemplary embodiment, in the case of performing Multi-Link communication, the communication unit 204 is an interface which performs communications with a plurality of frequency bands including a 2.4 GHz band, a 5 GHz band, and a 6 GHz band.

However, the plurality of frequency bands does not necessarily need to be limited to the above-mentioned frequency bands, and, for example, a different frequency band such as a 60 GHz band can also be used, so that, in that case, the communication unit 204 is an interface which is capable of performing communications with a 60 GHz band.

Moreover, the communication unit 204 is able to perform communications with use of bandwidths of 20 MHz, 40 MHz, 80 MHz, 160 MHz, and 320 MHz.

Furthermore, the bandwidths which the communication unit 304 (described below) of the information equipment 300 uses for communications are also similar to those described with regard to the communication unit 204.

Additionally, the bandwidths which the communication unit 204 and the communication unit 304 (described below) of the information equipment 300 use can be, for example, different bandwidths such as 240 MHz and 4 MHz.

### <TID Allocation Unit 205>

In establishing Multi-Link connection with an external apparatus such as the information equipment 300, the TID allocation unit 205 performs allocation of TIDs to the link 101, the link 102, and the link 103, and notifies the control unit 201 of a result of the allocation.

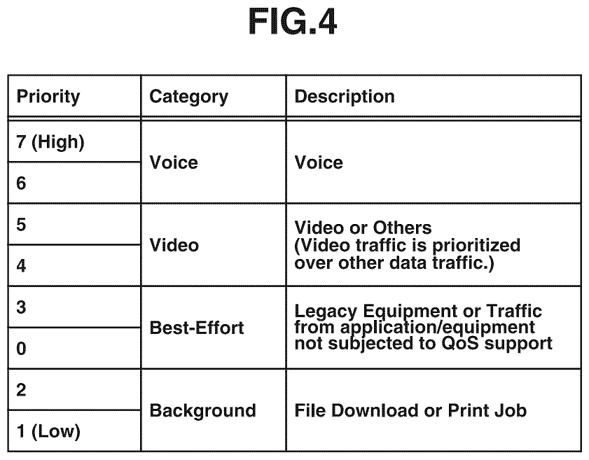

Furthermore, the details of TIDs are described below with reference to FIG. 4.

### <Communication Availability or Unavailability Determination Unit 206>

The communication availability or unavailability determination unit 206 is an example of a determination unit according to an aspect of the present disclosure, and determines whether data which each link connecting to the information equipment 300 handles in a predetermined category of TIDs is in a state of being able to be communicated.

Examples of information used for performing such determination include the number of times of retransmission to the information equipment 300 and the receiving sensitivity (i.e., the radio field intensity) of a packet received from the information equipment 300.

For example, each time retransmission occurs in the communication unit 204, a notification indicating the occurrence of retransmission is issued to the communication availability or unavailability determination unit 206 via the control unit 201.

Then, in the first exemplary embodiment, as an example, based on the number of times of retransmission, the communication availability or unavailability determination unit 206 determines whether data to be handled in Video is in a state of being able to be communicated.

If the number of times of retransmission to the information equipment 300 per unit time of data to be handled in Video exceeds a first number-of-times upper limit value, the communication availability or unavailability determination unit 206 determines that a link in which the number of times of retransmission has exceeded the first number-of-times upper limit value is not in a state of being able to perform communication and then notifies the control unit 201 of that effect.

Moreover, if the radio field intensity of a packet received from the information equipment 300 per unit time falls below a first intensity lower limit value, the communication availability or unavailability determination unit 206 determines that a link in which the radio field intensity has fallen below the first intensity lower limit value is not in a state of being able to perform communication and then notifies the control unit 201 of that effect.

In this way, if the radio field intensity per unit time of the information equipment 300 falls below the first intensity lower limit value, the communication availability or unavailability determination unit 206 determines that a link in which the radio field intensity has fallen below the first intensity lower limit value is not in a state of being able to perform communication and then notifies the control unit 201 of that effect.

Furthermore, the above-mentioned first number-of-times upper limit value and first intensity lower limit value can vary depending on, for example, categories of TIDs or frequency bands.

The above-mentioned first number-of-times upper limit value and first intensity lower limit value are a first determination condition, and the communication availability or unavailability determination unit 206, which functions as a determination unit, determines, based on the first determination condition, that a specific type of data (in the first exemplary embodiment, data to be handled in Video) is not in a state of being able to be communicated.

On the other hand, if the number of times of retransmission to the information equipment 300 per unit time of data to be handled in Background falls below a second number-of-times upper limit value, the communication availability or unavailability determination unit 206 determines that data to be handled in Video is in a state of being able to be communicated and then notifies the control unit 201 of that effect.

Furthermore, the second number-of-times upper limit value is the number of times of retransmission which is set less than or equal to the first number-of-times upper limit value.

Moreover, for example, if the radio field intensity of a packet received from the information equipment 300 per unit time exceeds a second intensity lower limit value, the communication availability or unavailability determination unit 206 determines that data to be handled in Video is in a state of being able to be communicated and then notifies the control unit 201 of that effect.

In this way, if the radio field intensity per unit time of the information equipment 300 exceeds the second intensity lower limit value, the communication availability or unavailability determination unit 206 determines that data to be handled in Video is in a state of being able to be communicated and then notifies the control unit 201 of that effect.

Furthermore, the second intensity lower limit value is a radio field intensity which is set greater than or equal to the first intensity lower limit value.

The above-mentioned second number-of-times upper limit value and second intensity lower limit value are a second determination condition, and the communication availability or unavailability determination unit 206, which functions as a determination unit, determines, based on the second determination condition, that a specific type of data (in the first exemplary embodiment, data to be handled in Video) is in a state of being able to be communicated.

### <Multi-Link Required Information Generation Unit 207>

The Multi-Link required information generation unit 207 generates information needed for transmitting a frame required to establish Multi-Link to an external apparatus such as the information equipment 300.

Furthermore, the Multi-Link required information generation unit 207 is an example of a setting unit which sets TID-to-Link Mapping according to an aspect of the present disclosure.

Specifically, examples of the information which the Multi-Link required information generation unit 207 generates include a Basic Multi-Link Element for determining whether to use Multi-Link for connection.

TID-to-Link Mapping is included in the Basic Multi-Link Element.

Besides, examples of the information which the Multi-Link required information generation unit 207 generates include a Reduced Neighbor Report (RNR) Element, including the frequency band and channel information about another affiliated AP belonging to the same AP MLD.

Moreover, although described below, the Multi-Link required information generation unit 207, which functions as a setting unit, resets TID-to-Link Mapping according to the determination as to whether data to be handled in Video is in a state of being able to be communicated performed by the communication availability or unavailability determination unit 206, which functions as a determination unit.

Furthermore, TID-to-Link Mapping which has been reset is notified from the Multi-Link required information generation unit 207, which functions as a setting unit, to the communication unit 204 via the control unit 201, and is than transmitted from the communication unit 204 to the information equipment 300.

### <Operation Unit 208>

The operation unit 208 is used to receive, from the user, an instruction issued by the user to the image capturing apparatus 200.

The operation unit 208 includes, for example, a power button used for the user to issue an instruction for powering on or off the image capturing apparatus 200, a release button used for the user to issue an instruction for performing image capturing, and a reproduction button used for the user to issue an instruction for reproducing image data.

Additionally, the operation unit 208 includes an operation button such as a dedicated connection button for starting a communication with an external apparatus such as the information equipment 300 via the communication unit 204.

Moreover, a touch panel which is formed in the display unit 203 is also included in the operation unit 208.

### <Image Capturing Unit 209>

The image capturing unit 209 is configured with, for example, an optical lens unit, an optical system for controlling, for example, the aperture, zoom, and focus of the optical lens unit, and an image sensor for converting light (video image) introduced via the optical lens unit into an electrical video signal.

The image sensor to be used is, generally, a complementary metal-oxide semiconductor (CMOS) sensor or a charge-coupled device (CCD) sensor.

Moving image data which is transmitted to the information equipment 300 in the first exemplary embodiment is generated by the image capturing unit 209.

Thus far is the description of the block diagram illustrating a functional configuration example of the image capturing apparatus 200 in the first exemplary embodiment.

Furthermore, as mentioned above, although not illustrated, the information equipment 300 can be considered to also have a configuration similar to that of the image capturing apparatus 200.

Thus, the information equipment 300 includes a control unit 301, a storage unit 302, a display unit 303, a communication unit 304, a TID allocation unit 305, a communication availability or unavailability determination unit 306, a Multi-Link required information generation unit 307, an operation unit 308, and an image capturing unit 309.

Then, the control unit 301, the storage unit 302, the display unit 303, the communication unit 304, the TID allocation unit 305, and the communication availability or unavailability determination unit 306 are similar to the control unit 201, the storage unit 202, the display unit 203, the communication unit 204, the TID allocation unit 205, and the communication availability or unavailability determination unit 206, respectively.

Moreover, the Multi-Link required information generation unit 307, the operation unit 308, and the image capturing unit 309 are similar to the Multi-Link required information generation unit 207, the operation unit 208, and the image capturing unit 209, respectively.

Accordingly, with regard to the functional configuration of the information equipment 300, the description of the functional configuration of the image capturing apparatus 200 should be referred to.

Furthermore, the information equipment 300 can have a functional configuration different from that of the image capturing apparatus 200, and, conversely, the information equipment 300 does not need to include a configuration which is not indispensable for implementing every embodiment of the present disclosure.

### <Hardware Configurations of Image Capturing Apparatus 200 and Information Equipment 300>

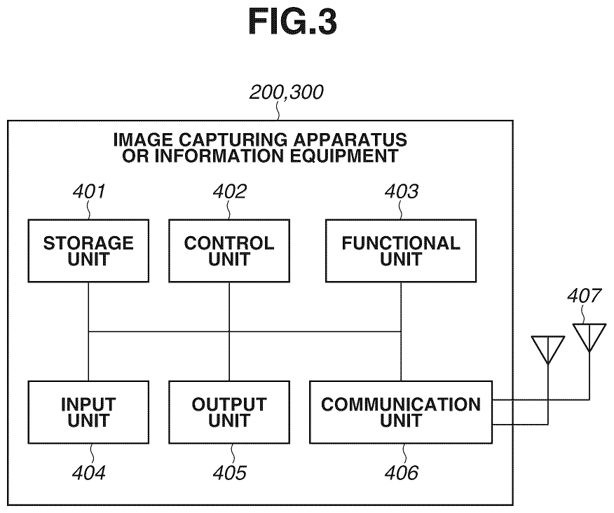

FIG. 3 is a block diagram illustrating a hardware configuration example of each of the image capturing apparatus 200 and the information equipment 300 according to the first exemplary embodiment.

Each of the image capturing apparatus 200 and the information equipment 300 includes a storage unit 401, a control unit 402, a functional unit 403, an input unit 404, an output unit 405, a communication unit 406, and an antenna 407.

Furthermore, the antenna 407 can be a plurality of antennas.

### <Storage Unit 401>

The storage unit 401 is configured with one or more memories such as ROMs or RAMs, and stores various pieces of information such as computer programs for performing various operations described below and communication parameters for wireless communication.

Furthermore, ROM is an abbreviation for read-only memory, and RAM is an abbreviation for random access memory.

Furthermore, the storage unit 401 to be used can be, in addition to memories such as a ROM or a RAM, a storage medium such as a flexible disc, a hard disk, an optical disc, a magneto-optical disk, a compact disc (CD)-ROM, a CD recordable (CD-R), a magnetic tape, a non-volatile memory card, or a digital versatile disc (DVD).

Moreover, the storage unit 401 can be configured to include, for example, a plurality of memories.

### <Control Unit 402>

The control unit 402 is configured with, for example, one or more processors such as CPUs or MPUs, and the control unit 402 of the image capturing apparatus 200 controls the entire image capturing apparatus 200 by executing computer programs stored in the storage unit 401.

Moreover, the above is also applicable to the control unit 402 of the information equipment 300, and the control unit 402 of the information equipment 300 controls the entire information equipment 300.

Furthermore, CPU is an abbreviation for central processing unit, and MPU is an abbreviation for micro processing unit.

Moreover, the control unit 402 can be configured to control the entire image capturing apparatus 200 by causing a computer program and an operating system (OS) stored in the storage unit 401 to cooperate with each other, and this is also applicable to the information equipment 300.

Additionally, the control unit 402 can include a plurality of processors such as a multi-core processor and control the entire image capturing apparatus 200 by the plurality of processors, and this is also applicable to the information equipment 300.

The control unit 402 generates, for example, data or a signal (wireless frame) to be transmitted in communications with another apparatus.

Moreover, the control unit 402 controls the functional unit 403 to perform predetermined processing operations such as wireless communication, image capturing, printing, and projection.

### <Functional Unit 403>

The functional unit 403 is hardware used for the image capturing apparatus 200 and the information equipment 300 to perform predetermined processing operations with the above-described functional configurations.

### <Input Unit 404>

The input unit 404 performs reception of various operations performed by the user.

### <Output Unit 405>

The output unit 405 performs various outputting operations to the user via a monitor screen or a loudspeaker.

Here, the outputting operations which are performed by the output unit 405 can be, for example, displaying on the monitor screen, voice output using the loudspeaker, and vibration output.

Furthermore, both the input unit 404 and the output unit 405 can be implemented with one module such as a touch panel.

Moreover, each of the input unit 404 and the output unit 405 can be integral with the image capturing apparatus 200 or can be separate from the image capturing apparatus 200, and this is also applicable to the input unit 404 and the output unit 405 of the information equipment 300.

### <Communication Unit 406>

The communication unit 406 performs control of wireless communication conforming to the IEEE 802.11be standard.

Moreover, the communication unit 406 can perform control of wireless communication conforming to, in addition to the IEEE 802.11be standard, another IEEE 802.11 series standard or control of wired communication such as a wired LAN.

The communication unit 406 controls the antenna 407 to perform transmission and reception of a signal for wireless communication generated by the control unit 402.

Furthermore, in a case where the image capturing apparatus 200 and the information equipment 300 are compatible with, in addition to the IEEE 802.11be standard, for example, the NFC standard or the Bluetooth® standard, the communication unit 406 can perform control of wireless communication conforming to these communication standards.

Moreover, in a case where the image capturing apparatus 200 and the information equipment 300 are able to perform wireless communication conforming to a plurality of communication standards, the image capturing apparatus 200 and the information equipment 300 can be configured to individually include communication units and antennas compatible with the respective communication standards.

The image capturing apparatus 200 communicates data such as image data, document data, and video data to the information equipment 300 via the communication unit 406.

Furthermore, the information equipment 300 is also able to perform communication with the image capturing apparatus 200 via the communication unit 406 of the information equipment 300.

### <Antenna 407>

The antenna 407 is an antenna available for communications in a 2.4 GHz band, a 5 GHz band, and a 6 GHz band.

Furthermore, the antenna 407 can be configured to be separate from the communication unit 406, or can be configured to be integrated with the communication unit 406 as a single module.

In the first exemplary embodiment, each of the image capturing apparatus 200 and the information equipment 300 includes two antennas, but can be configured to include three antennas.

Moreover, each of the image capturing apparatus 200 and the information equipment 300 can include antennas different for every frequency band.

Additionally, in the case of including a plurality of antennas, each of the image capturing apparatus 200 and the information equipment 300 can include communication units 406 corresponding to the respective antennas.

### <TIDs and Access Categories>

FIG. 4 is a schematic diagram of Traffic IDs (TIDs) and access categories according to the first exemplary embodiment.

TIDs are identifiers which take the values of 0 to 7 and are used to classify packets.

The identifiers are assigned the respective priority orders for transmitting packets and are set as 7, 6, 5, 4, 3, 0, 2, and 1 in the order of higher priority.

Additionally, TIDs are classified into four categories depending on intended uses.

Categories Voice (7, 6), Video (5, 4), Best-Effort (3, 0), and Background (2, 1) are defined in the order of higher degree of priority.

As illustrated in FIG. 4, Voice corresponds to voice, and Video corresponds to video or others (video traffic is prioritized over other data traffic).

Moreover, Best-Effort corresponds to traffic from legacy equipment or application/equipment not subjected to QoS support, and Background corresponds to File Download or print job.

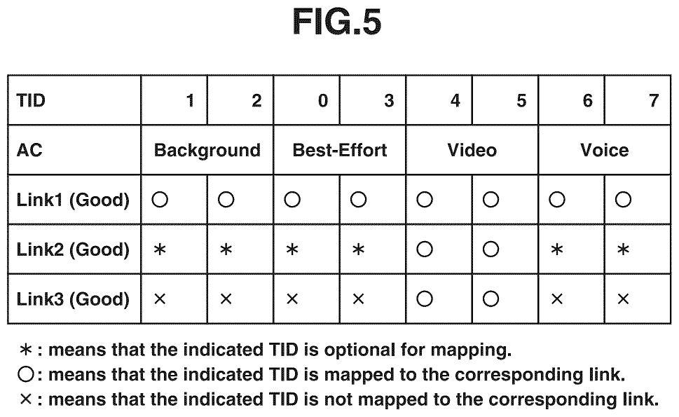

Furthermore, which a category of which TID is allocated to each of the links (the link 101, the link 102, and the link 103) in the first exemplary embodiment is described below with reference to FIG. 5.

For example, in the case of sending a moving image recorded by the image capturing apparatus 200, the TID is set to 5 or 4 in the category Video.

More specifically, the TID can be set to 5 in the case of a moving image and to 4 in the case of a still image.

Moreover, with regard to control of the image capturing apparatus 200 or others, the TID is set to 2 or 1 and the category is set to Background.

More specifically, with regard to control of the image capturing apparatus 200, the TID can be set to 2 and, with regard to others, the TID can be set to 1.

FIG. 5 is a diagram illustrating an allocation example of TID-to-Link Mapping indicating how categories of TIDs are allocated to the respective links according to the first exemplary embodiment.

Furthermore, in FIG. 5, the link 101 is denoted by Link1, the link 102 is denoted by Link2, and the link 103 is denoted by Link3.

Moreover, FIG. 5 is a diagram illustrating an allocation example of TID-to-Link Mapping which is performed when the image capturing apparatus 200 and the information equipment 300 have been interconnected for the first time.

Link1 is compatible with all of the TIDs, and, in other words, all of the categories of TIDs are allocated to Link1.

Link2 is compatible with the category Video of TIDs, and the other categories of TIDs are optional for mapping.

Link3 is compatible with only the category Video of TIDs. <Sequence of Reallocation of TID-to-Link Mapping>

Next, a sequence of reallocation of TID-to-Link Mapping is described.

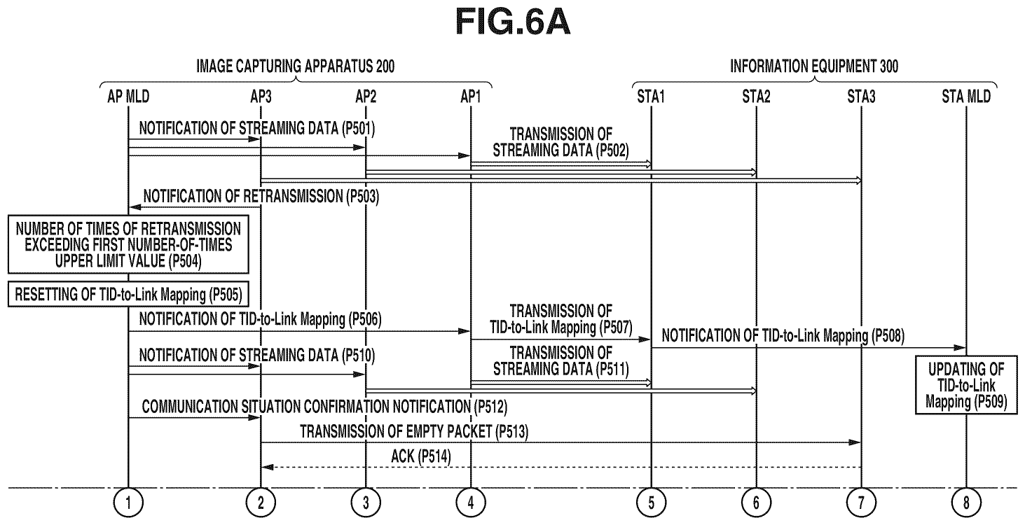

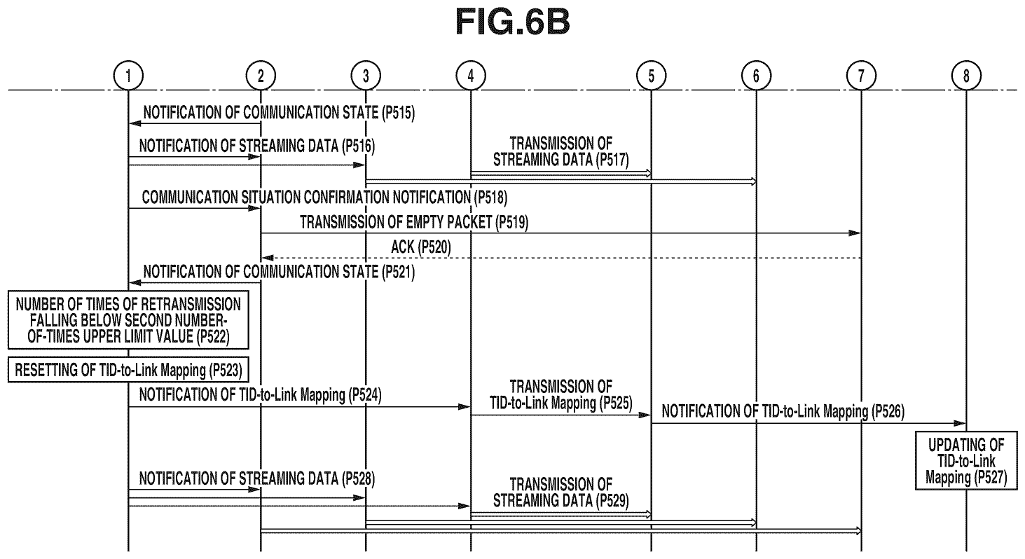

FIGS. 6A and 6B are sequence diagrams illustrating the flow of operations for performing reallocation of TID-to-Link Mapping according to the first exemplary embodiment.

In the first exemplary embodiment, the image capturing apparatus 200 is denoted by AP MLD, and the information equipment 300 is denoted by STA MLD.

The image capturing apparatus 200 generates streaming data, and transmits the generated streaming data to the information equipment 300.

The image capturing apparatus 200 includes an AP1 (access point 1), an AP2 (access point 2), and an AP3 (access point 3) as affiliated access points (APs) associated with the respective frequency bands available for data communication, which belong to the communication unit 204.

Similarly, the information equipment 300 also includes an STA1 (station 1), an STA2 (station 2), and an STA3 (station 3) as affiliated stations (STAs), which belong to the communication unit 304.

The AP1 and STA1 are allocated to link ID=1 (i.e., a link with link ID being 1), the AP2 and STA2 are allocated to link ID=2 (i.e., a link with link ID being 2), and the AP3 and STA3 are allocated to link ID=3 (i.e., a link with link ID being 3).

Furthermore, it is assumed that the link to which link ID=1 is allocated is Link1, the link to which link ID=2 is allocated is Link2, and the link to which link ID=3 is allocated is Link3.

Here, it is premised that the image capturing apparatus 200 and the information equipment 300 have already been interconnected, they have become ready to transmit streaming data, and a radio wave environment of a frequency band which link ID=3 is using is deteriorated.

Moreover, it is assumed that the categories of TIDs to which Link1, Link2, and Link3 correspond when the image capturing apparatus 200 and the information equipment 300 have been interconnected for the first time are in the states illustrated in FIG. 5.

Furthermore, processing operations which are performed after the information equipment 300 has received streaming data are omitted.

In step P501, the control unit 201 notifies the AP1, AP2, and AP3 of the communication unit 204 of streaming data notified from the image capturing unit 209.

In step P502, the AP1, AP2, and AP3 of the communication unit 204 transmit streaming data to the STA1, STA2, and STA3 of the communication unit 304.

In step P503, each time retransmission occurs at the communication unit 204, the communication unit 204 notifies the communication availability or unavailability determination unit 206 via the control unit 201 of information indicating retransmission being performed.

In FIGS. 6A and 6B, it is assumed that retransmission has occurred at link ID=3.

In step P504, the communication availability or unavailability determination unit 206 measures the number of times of retransmission occurring within a fixed time at every link.

Then, if the number of times of retransmission of link ID=3 per unit time exceeds the first number-of-times upper limit value, the communication availability or unavailability determination unit 206, which serves as a determination unit, determines that link ID=3 which the AP3 is using is not in a state of being able to communicate data to be handled in Video.

The above-mentioned data to be handled in Video is an example of a specific type of data according to an aspect of the present disclosure.

Furthermore, a configuration in which, if the radio field intensity per unit time of link ID=3 falls below the first intensity lower limit value, the communication availability or unavailability determination unit 206 determines that link ID=3 which the AP3 is using is not in a state of being able to communicate data to be handled in Video can be employed.

In this case, the communication availability or unavailability determination unit 206 measures the radio field intensity of link ID=3 instead of the number of times of retransmission thereof.

Then, the communication availability or unavailability determination unit 206 notifies the control unit 201 of a result of determination, and the control unit 201 notifies the Multi-Link required information generation unit 207 of information indicating that link ID=3 is not in a state of being able to communicate data to be handled in Video.

Moreover, the control unit 201 notifies the Multi-Link required information generation unit 207 of information indicative of performing resetting of TID-to-Link Mapping.

Then, in step P505, the Multi-Link required information generation unit 207, which functions as a setting unit, resets TID-to-Link Mapping in such a way as to cause link ID=3 not to include Video.

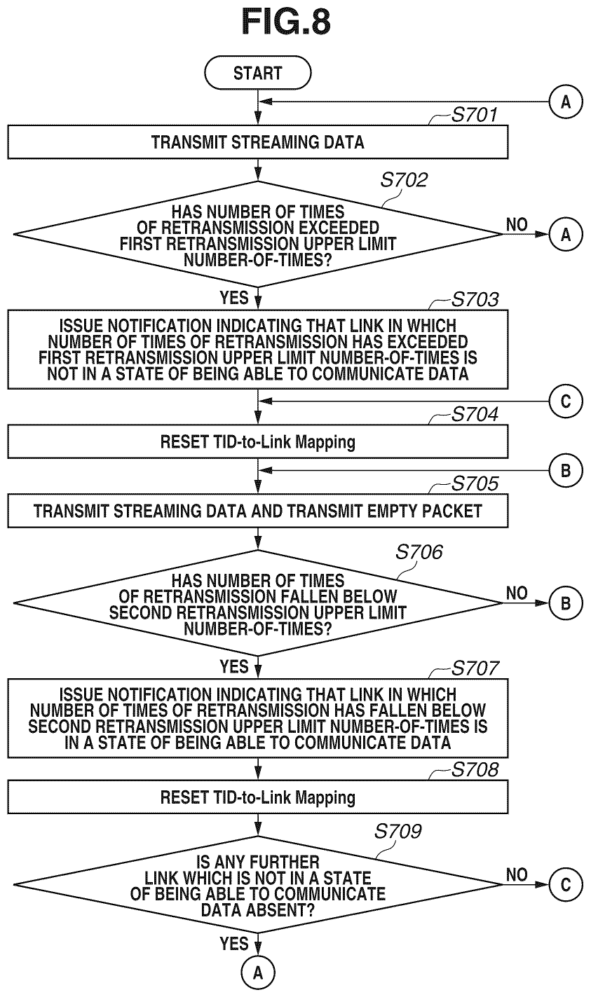

The method of setting TID-to-Link Mapping is described below with reference to FIG. 8.

In step P506, then, TID-to-Link Mapping which has been reset is notified from the Multi-Link required information generation unit 207 to the AP1 of the communication unit 204 via the control unit 201.

Next, in step P507, the AP1 of the communication unit 204 transmits the reset TID-to-Link Mapping to the STA1 of the communication unit 304.

In this way, the reset TID-to-Link Mapping is transmitted to the information equipment 300, which is opposite equipment.

Then, in step P508, in the information equipment 300, the STA1 of the communication unit 304 notifies the control unit 301 of the reset TID-to-Link Mapping.

Moreover, in the information equipment 300, the control unit 301 notifies the Multi-Link required information generation unit 307 of the reset TID-to-Link Mapping.

Then, in step P509, the Multi-Link required information generation unit 307 performs updating of TID-to-Link Mapping.

Thus, the Multi-Link required information generation unit 307 reflects the setting of TID-to-Link Mapping reset by the image capturing apparatus 200 in TID-to-Link Mapping set thus far.

Then, in step P510, in the image capturing apparatus 200, the control unit 201 notifies the AP1 and AP2 of the communication unit 204 of streaming data notified from the image capturing unit 209 in association with the reset TID-to-Link Mapping.

Thus, the control unit 201 does not notify the AP3 of the communication unit 204 of streaming data.

In step P511, the AP1 and AP2 of the communication unit 204 transmit streaming data to the STA1 and STA2 of the communication unit 304 via link ID=1 and link ID=2, respectively.

On the other hand, in step P512, the control unit 201 issues, to the AP3 of the communication unit 204, a notification for causing the AP3 to monitor a communication situation of link ID=3 (a communication situation confirmation notification).

Then, in step P513, the AP3 of the communication unit 204 transmits an empty packet to the STA3 of the communication unit 304 according to the communication situation confirmation notification.

On the other hand, in step P514, the STA3 of the communication unit 304 returns ACK (acknowledgement) to the AP3 of the communication unit 204 as a response to the transmitted empty packet.

In step P515, upon receiving ACK, the AP3 of the communication unit 204 notifies the control unit 201 of a communication state of link ID=3.

Furthermore, the communication state is made to include the presence or absence of a response from the information equipment 300 serving as opposite equipment.

The control unit 201 notifies the communication availability or unavailability determination unit 206 of the communication state of link ID=3 received from the AP3 of the communication unit 204.

The communication availability or unavailability determination unit 206 measures the number of times of retransmission occurring within a fixed time.

For example, at this time, since the number of times of retransmission occurring within a fixed time does not fall below a second upper limit number-of-times (second number-of-times upper limit value), which is less than or equal to a first upper limit number-of-times (first number-of-times upper limit value in the number of times of retransmission occurring within the fixed time), the communication availability or unavailability determination unit 206 is assumed to perform nothing.

In step P516 to step P521, as mentioned above, if the number of times of retransmission occurring within the fixed time does not fall below the second upper limit number-of-times (second number-of-times upper limit value), processing operations in step P516 to step P521, which are processing operations similar to those in step P510 to step P515, are performed.

Thus, unless the number of times of retransmission occurring within the fixed time falls below the second upper limit number-of-times (second number-of-times upper limit value), processing operations similar to those in step P510 to step P515 are repeated.

Furthermore, even when processing operations similar to those in step P510 to step P515 are being performed, as in step P504, the communication availability or unavailability determination unit 206 measures the number of times of retransmission occurring within the fixed time.

Moreover, while, in the illustration of FIGS. 6A and 6B, a series of processing operations in step P516 to step P521, which are processing operations similar to those in step P510 to step P515, is performed once, unless the number of times of retransmission occurring within the fixed time falls below the second upper limit number-of-times (second number-of-times upper limit value), the series of processing operations in step P516 to step P521 is repeated over and over again.

Then, in step P522, it is assumed that, while processing operations similar to those in step P510 to step P515 are repeated, the number of times of retransmission occurring within the fixed time has fallen below the second upper limit number-of-times, which is less than or equal to the first upper limit number-of-times.

Then, the communication availability or unavailability determination unit 206 determines that link ID=3 which the AP3 is using is in a state of being able to communicate data to be handled in Video.

Thus, if the number of times of retransmission per unit time falls below the second number-of-times upper limit value, which is less than or equal to the first number-of-times upper limit value, the communication availability or unavailability determination unit 206 determines that link ID=3 which the AP3 is using is in a state of being able to communicate data to be handled in Video.

Furthermore, a configuration in which, if the radio field intensity per unit time of link ID=3 exceeds the second intensity lower limit value, the communication availability or unavailability determination unit 206 determines that link ID=3 which the AP3 is using is in a state of being able to communicate data to be handled in Video can be employed.

In this case, the communication availability or unavailability determination unit 206 measures the radio field intensity of link ID=3 instead of the number of times of retransmission thereof.

Then, the communication availability or unavailability determination unit 206 notifies the control unit 201 of a result of determination, and the control unit 201 notifies the Multi-Link required information generation unit 207 of information indicating that link ID=3 is in a state of being able to communicate data to be handled in Video.

Moreover, the control unit 201 notifies the Multi-Link required information generation unit 207 of information indicative of performing resetting of TID-to-Link Mapping.

Then, in step P523, the Multi-Link required information generation unit 207, which functions as a setting unit, resets TID-to-Link Mapping in such a way as to cause link ID=3 to include Video.

Then, in step P524, TID-to-Link Mapping which has been reset is notified from the Multi-Link required information generation unit 207 to the AP1 of the communication unit 204 via the control unit 201.

Next, in step P525, the AP1 of the communication unit 204 transmits the reset TID-to-Link Mapping to the STA1 of the communication unit 304.

In this way, the reset TID-to-Link Mapping is transmitted to the information equipment 300, which is opposite equipment.

Then, in step P526, in the information equipment 300, the STA1 of the communication unit 304 notifies the control unit 301 of the received TID-to-Link Mapping (the reset TID-to-Link Mapping).

Moreover, in the information equipment 300, the control unit 301 notifies the Multi-Link required information generation unit 307 of the reset TID-to-Link Mapping.

Then, in step P527, the Multi-Link required information generation unit 307 performs updating of TID-to-Link Mapping.

Thus, the Multi-Link required information generation unit 307 reflects the setting of TID-to-Link Mapping reset by the image capturing apparatus 200 in TID-to-Link Mapping set thus far.

In step P528, the control unit 201 performs a processing operation similar to that in step P501.

Thus, in the image capturing apparatus 200, in association with the reset TID-to-Link Mapping, the control unit 201 notifies the AP1, AP2, and AP3 of the communication unit 204 of streaming data notified from the image capturing unit 209.

Then, in step P529, the AP1, AP2, and AP3 of the communication unit 204 transmit streaming data to the STA1, STA2, and STA3 of the communication unit 304, respectively.

Thus far is the description of the sequence diagram for performing reallocation of TID-to-Link Mapping according to the first exemplary embodiment.

### <Information Element for TID-to-Link Mapping>

Next, an information element used for exchanging information about TID-to-Link Mapping is described.

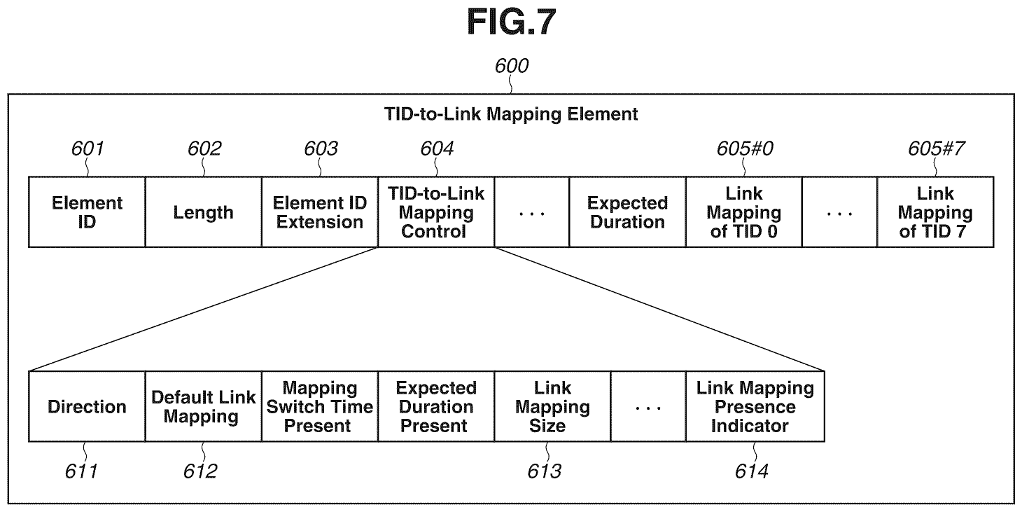

FIG. 7 is a diagram illustrating an example of an information element for communicating information about TID-to-Link Mapping according to the first exemplary embodiment.

An AP or an STA exchanges a frame including the information element to perform initial setting of TID-to-Link Mapping or perform resetting thereof.

In TID-to-Link Mapping, information about TID-to-Link Mapping is expressed with use of a TID-to-Link Mapping Element 600.

The TID-to-Link Mapping Element 600 includes an Element ID field 601, a Length field 602, and an Element ID Extension field 603.

Moreover, the TID-to-Link Mapping Element 600 further includes a TID-to-Link Mapping Control field 604 and a Link Mapping of TID n field 605.

The Element ID field 601 and the Element ID Extension field 603 are used to indicate that the Element is a TID-to-Link Mapping Element.

The values of the Element ID field 601 and the Element ID Extension field 603 are assumed to be 255 and 109, respectively.

The Length field 602 indicates the length of the Element.

The TID-to-Link Mapping Control field 604 is indicated by frames.

The TID-to-Link Mapping Control field 604 includes a Direction field 611 and a Default Link Mapping field 612.

Moreover, the TID-to-Link Mapping Control field 604 further includes a Link Mapping Size field 613 and a Link Mapping Presence Indicator field 614.

The Direction field 611 indicates the direction of communication.

In the case of indicating only downlink communication, 0 is assigned to the Direction field 611, in the case of indicating only uplink communication, 1 is assigned to the Direction field 611, and, in the case of indicating both, 2 is assigned to the Direction field 611.

Furthermore, the Direction field 611 is not indispensable, or a plurality of Direction fields 611 can be provided.

For example, the Direction field 611 can be appended for each of downlink and uplink.

The Default Link Mapping field 612 is a field indicating whether to set TID-to-Link Mapping to a default value.

The Default Link Mapping field 612 being 1 indicates using a default value.

Here, the default value is assumed to indicate a state in which all of the TIDs, i.e., all of the categories of TIDs, are allocated to all of the Links to enable any communications.

In the other cases, the Default Link Mapping field 612 is set to 0.

For example, in the case of disabling communication with respect to a given link, the value of the Default Link Mapping field 612 is set to 0.

In the first exemplary embodiment, since only a link for moving data, a link for other data such as for control, and data to be handled in a predetermined category of TIDs are transmitted, the Default Link Mapping field 612 is set to 0.

The Link Mapping Size field 613 indicates the length of the Link Mapping of TID n field 605 following thereon. In the case of the Link Mapping Size field 613 being 1, the length of the Link Mapping of TID n field 605 is 1 octet, and in the case of the Link Mapping Size field 613 being 0, the length of the Link Mapping of TID n field 605 is 2 octets.

The Link Mapping Presence Indicator field 614 is formed as a bitmap for indicating whether a field exists for each TID with respect to the Link Mapping of TID n field 605.

For example, in a case where the first bit of the Link Mapping Presence Indicator field 614 is set to 1, it is indicated that a Link Mapping of TID 0 field 605#0 corresponding to TID 0 exists.

Furthermore, in a case where the Default Link Mapping field 612 is set to 1, the Link Mapping Presence Indicator field 614 does not exist.

However, in the first exemplary embodiment, since the Default Link Mapping field 612 is set to 0, the Link Mapping Presence Indicator field 614 exists.

In the Link Mapping of TID n field 605, eight Link Mappings corresponding to n=0 to n=7 exist, and the bit position indicates Link ID.

In the first exemplary embodiment, the link 101 is indicated by the first bit as LINK ID=1, the link 102 is indicated by the second bit as LINK ID=2, and the link 103 is indicated by the third bit as LINK ID=3.

With regard to allocation of links, as described above with reference to FIG. 5, Link1 with link ID=1 is compatible with all of the TIDs, i.e., all of the categories of TIDs.

Link2 with link ID=2 is compatible with TID=4 and TID=5, i.e., the category Video, and is optionally compatible with the other categories of TIDs.

Link3 with link ID=3 is compatible with only TID=4 and TID=5, i.e., only the category Video.

At this time, in the Link Mapping of TID 4 and the Link Mapping of TID 5, since the first bit, the second bit, and the third bit become 1, the value thereof becomes 0×7.

Moreover, in the Link Mapping of TIDs other than TID=4 and TID=5, since the first bit becomes 1 and the second bit becomes 1 or 0, the value thereof becomes 0×3 or 0×1.

Accordingly, equipment which has received TID-to-Link Mapping becomes able to determine which data to transmit via which link, by checking the Link Mapping of TID n field 605.

Thus far is the description of an information element for exchanging information about TID-to-Link Mapping according to the first exemplary embodiment.

### <Flowchart of Reallocation of TID-to-Link Mapping>

Next, a flowchart of reallocation of TID-to-Link Mapping is described.

FIG. 8 is a flowchart illustrating processing for performing reallocation of TID-to-Link Mapping according to the first exemplary embodiment.

In step S701, the control unit 201 causes the communication unit 204 to transmit streaming data to the communication unit 304.

In step S702, the communication availability or unavailability determination unit 206 acquires a retransmission situation of each link from the communication unit 204 via the control unit 201 and determines whether, in each link, the number of times of retransmission within a fixed time has exceeded the first retransmission upper limit number-of-times (the first number-of-times upper limit value), and, if it is determined that the number of times of retransmission within the fixed time has not exceeded the first retransmission upper limit number-of-times (the first number-of-times upper limit value) (NO in step S702), the communication availability or unavailability determination unit 206 returns the processing to step S701.

On the other hand, if it is determined that the number of times of retransmission within the fixed time has exceeded the first retransmission upper limit number-of-times (YES in step S702), the communication availability or unavailability determination unit 206 determines that the link in which the number of times of retransmission within the fixed time has exceeded the first retransmission upper limit number-of-times is not in a state of being able to communicate data to be handled in Video, and thus advances the processing to step S703.

Thus, in a case where the number of times of retransmission per unit time has exceeded the first number-of-times upper limit value, the communication availability or unavailability determination unit 206 determines that the link in which the number of times of retransmission within the fixed time has exceeded the first number-of-times upper limit value is not in a state of being able to communicate data to be handled in Video, and thus advances the processing to step S703.

In the first exemplary embodiment, as explained above, link ID=3 (Link3) corresponds to that link.

Furthermore, as explained above, the determination as to whether the number of times of retransmission per unit time has exceeded the first number-of-times upper limit value can be replaced with the determination as to whether the radio field intensity per unit time has fallen below the first intensity lower limit value.

Then, in step S703, the communication availability or unavailability determination unit 206 notifies the control unit 201 of a result of determination indicating that the link in which the number of times of retransmission within the fixed time has exceeded the first retransmission upper limit number-of-times (the first number-of-times upper limit value) (in this example, the link of link ID=3) is not in a state of being able to communicate data to be handled in Video.

Moreover, the control unit 201 notifies the Multi-Link required information generation unit 207 of information indicating that link ID=3 is not in a state of being able to communicate data to be handled in Video and information indicative of performing resetting of TID-to-Link Mapping.

Then, in step S704, the Multi-Link required information generation unit 207 performs processing for resetting TID-to-Link Mapping in such a way as to cause link ID=3 not to include Video, according to the notification indicative of performing resetting.

Specifically, the Multi-Link required information generation unit 207 generates a TID-to-Link Mapping Request frame including a TID-to-Link Mapping Element configured in such a way as to cause link ID=3 not to include Video.

In a destination field for that frame, a media access control (MAC) address of the STA1 is designated.

The generated Request frame is notified from the Multi-Link required information generation unit 207 to the AP1 of the communication unit 204 via the control unit 201.

The AP1 of the communication unit 204 having received the notification transmits the notified Request frame, as a PPDU such as EHT PPDU or UHR PPDU, to, for example, the STA1 of the communication unit 304 of the opposite equipment (information equipment 300) via the AP1 of the communication unit 204.

The opposite equipment (information equipment 300) determines whether such a change is acceptable, and, upon determining that such a change is acceptable, generates a TID-to-Link Mapping Response frame with 0 (Success) set to Status Code.

Moreover, the opposite equipment (information equipment 300) transmits the generated Response frame as a PPDU such as EHT PPDU or UHR PPDU to a transmission source of the Request frame.

Upon receiving the Response frame with 0 (Success) set to Status Code in cooperation with the communication unit 204, the Multi-Link required information generation unit 207 deems that resetting has been accepted by the opposite party and thus resets the setting of the Multi-Link required information generation unit 207 itself.

Thus, in cooperation with each unit, the Multi-Link required information generation unit 207 performs resetting in TID-to-Link Mapping in such a way as to cause link ID=3 not to include Video.

Furthermore, as explained above with reference to FIGS. 6A and 6B, in the information equipment 300, processing for reflecting the setting of the reset TID-to-Link Mapping in TID-to-Link Mapping set thus far is performed.

In this way, in the information equipment 300, updating of TID-to-Link Mapping is performed.

In step S705, in conformity with the resetting of TID-to-Link Mapping, the control unit 201 notifies the AP1 and AP2 of the communication unit 204 of streaming data, and issues, to the AP3 of the communication unit 204, a notification for causing the AP3 to monitor a communication situation of link ID=3 (a communication situation confirmation notification).

Then, the AP1 and AP2 of the communication unit 204 transmit streaming data to the STA1 and STA2 of the communication unit 304, respectively, and the AP3 of the communication unit 204 transmits an empty packet to the STA3 of the communication unit 304.

Moreover, upon receiving ACK of the empty packet from the STA3 of the communication unit 304, the AP3 of the communication unit 204 notifies the control unit 201 of a communication state thereof, and the control unit 201 notifies the communication availability or unavailability determination unit 206 of a communication state of link ID=3 received from the AP3 of the communication unit 204.

In step S706, the communication availability or unavailability determination unit 206 determines whether the number of times of retransmission within the fixed time (the number of times of retransmission per unit time) has fallen below the second retransmission upper limit number-of-times (the second number-of-times upper limit value), which is less than or equal to the first retransmission upper limit number-of-times (the first number-of-times upper limit value), and if it is determined that the number of times of retransmission within the fixed time has not fallen below the second retransmission upper limit number-of-times (the second number-of-times upper limit value) (NO in step S706), the communication availability or unavailability determination unit 206 returns the processing to step S705.

On the other hand, if it is determined that the number of times of retransmission within the fixed time has fallen below the second retransmission upper limit number-of-times (YES in step S706), the communication availability or unavailability determination unit 206 determines that link ID=3 which the AP3 is using is in a state of being able to communicate data to be handled in Video, and then advances the processing to step S707.

Thus, in a case where the number of times of retransmission per unit time has fallen below the second number-of-times upper limit value, the communication availability or unavailability determination unit 206 determines that link ID=3 which the AP3 is using is in a state of being able to communicate data to be handled in Video, and thus advances the processing to step S707.

Furthermore, as explained above, the determination as to whether the number of times of retransmission per unit time has fallen below the second number-of-times upper limit value can be replaced with the determination as to whether the radio field intensity per unit time has exceeded the second intensity lower limit value.

Then, in step S707, the communication availability or unavailability determination unit 206 notifies the control unit 201 of a result of determination indicating that the link in which the number of times of retransmission within the fixed time has fallen below the second retransmission upper limit number-of-times (the second number-of-times upper limit value) (in this example, the link of link ID=3) is in a state of being able to communicate data to be handled in Video.

Moreover, the control unit 201 notifies the Multi-Link required information generation unit 207 of information indicating that link ID=3 is in a state of being able to communicate data to be handled in Video and information indicative of performing resetting of TID-to-Link Mapping.

Then, in step S708, the Multi-Link required information generation unit 207 performs processing similar to that described in step S704, in cooperation with each unit.

Specifically, the Multi-Link required information generation unit 207 generates a TID-to-Link Mapping Request frame used for resetting, and performs exchange of the TID-to-Link Mapping Request frame with the information equipment 300 serving as opposite equipment.

Step S708 differs from step S704 in transmitting a TID-to-Link Mapping Request frame including a TID-to-Link Mapping Element configured in such a way as to cause link ID=3 to include Video.

Then, upon receiving the Response frame with 0 (Success) set to Status Code in cooperation with the communication unit 204, the Multi-Link required information generation unit 207 deems that resetting has been accepted by the opposite party and thus resets the setting of the Multi-Link required information generation unit 207 itself.

Thus, in cooperation with each unit, the Multi-Link required information generation unit 207 performs resetting in TID-to-Link Mapping in such a way as to cause link ID=3 to include Video.

Furthermore, as explained above with reference to FIGS. 6A and 6B, in the information equipment 300, processing for reflecting the setting of the reset TID-to-Link Mapping in TID-to-Link Mapping set thus far is performed.

In this way, in the information equipment 300, updating of TID-to-Link Mapping is performed.

After that, in step S709, the communication availability or unavailability determination unit 206 checks whether any further link which is not in a state of being able to communicate data to be handled in Video is absent.

If it is determined that any further link which is not in a state of being able to communicate data to be handled in Video is absent (YES in step S709), the communication availability or unavailability determination unit 206 returns the processing to step S701.

On the other hand, if it is determined that any further link which is not in a state of being able to communicate data to be handled in Video is present (NO in step S709), the communication availability or unavailability determination unit 206 returns the processing to step S704, thus performing resetting of TID-to-Link Mapping.

Thus far is the description of the flowchart for performing reallocation of TID-to-Link Mapping according to the first exemplary embodiment.

Next, an example of reallocation of TID-to-Link Mapping is described.

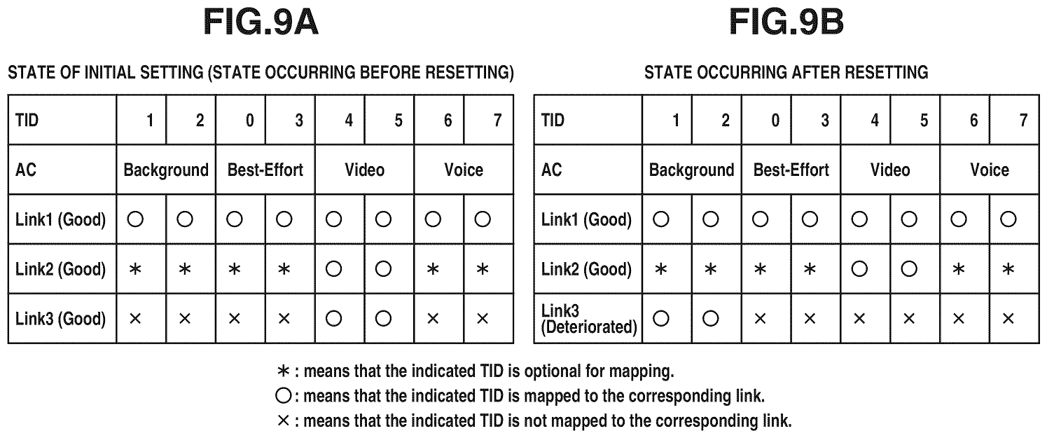

FIGS. 9A and 9B are diagrams used to explain an example of reallocation of TID-to-Link Mapping according to the first exemplary embodiment.

FIG. 9A illustrates a state of initial setting, i.e., an allocation state of TID-to-Link Mapping occurring when the image capturing apparatus 200 and the information equipment 300 have been interconnected for the first time (i.e., the state illustrated in FIG. 5).

Moreover, FIG. 9B illustrates a state occurring after reallocation (resetting) of TID-to-Link Mapping which has been performed when link ID=3 is not in a state of being able to communicate data to be handled in Video.

Furthermore, even in FIGS. 9A and 9B, as always, it is assumed that the link to which link ID=1 is allocated is Link1, the link to which link ID=2 is allocated is Link2, and the link to which link ID=3 is allocated is Link3.

The state of initial setting, i.e., the allocation state of TID-to-Link Mapping occurring when the image capturing apparatus 200 and the information equipment 300 have been interconnected for the first time (FIG. 9A), is as described above with reference to FIG. 5.

Specifically, Link1 is compatible with all of the TIDs, and, in other words, all of the categories of TIDs are allocated to Link1.

Moreover, Link2 is compatible with the category Video of TIDs, and the other categories of TIDs are optional for mapping.

Additionally, Link3 is compatible with only the category Video of TIDs.

Then, in the first exemplary embodiment, as illustrated in FIG. 9B, since link ID=3 has come into a state of being unable to communicate data to be handled in Video, performing resetting causes link ID=3 to be incompatible with TID=4 and TID=5 for Video.

Moreover, as illustrated in FIG. 9B, instead, performing resetting causes link ID=3 to be changed in such a way as to be compatible with only TID=1 and TID=2 for Background.

Furthermore, as can be understood from FIG. 9A and FIG. 9B, in the first exemplary embodiment, even after resetting is performed, link ID=1 and link ID=2 are in the same state as that of initial setting, so that changing is not performed by resetting.

Moreover, irrespective of the state of initial setting and the state occurring after resetting, setting is performed in such a manner that each value of TID is necessarily allocated to any link, thus preventing a state in which data to be handled in a given category of TIDs is unable to be transmitted in all of the links from occurring.

Thus, in order to prevent a state in which there is no link which is available for transmitting data to be handled in a given category of TIDs from occurring, setting is performed in such a manner that each category of TIDs is necessarily allocated to any link.

However, in a case where there is no link which is available for transmitting data to be handled in Video, by way of exception, TID=4 and TID=5 are not allocated to any link.

In this case, exception control for issuing a notification indicating that it is difficult to communicate data to be handled in Video or roaming control for trying to switch the connection destination to another AP can be performed.

Thus far is the description of an example of reallocation of TID-to-Link Mapping according to the first exemplary embodiment.

As described above, according to the first exemplary embodiment, when Multi-Link has been established between the image capturing apparatus 200 and the information equipment 300, if a link which is unable to communicate data to be handled in Video occurs, resetting is performed on TID-to-Link Mapping.

For example, in resetting of TID-to-Link Mapping, with respect to a link which is unable to communicate data to be handled in Video, setting is performed in such a way as to cause the link to communicate another piece of data, so that the link becomes able to perform appropriate communication according to a situation thereof.

In the first exemplary embodiment, as a specific example, a case has been described in which the category of TIDs with which link ID=3 is compatible is changed from Video to Background so that link ID=3 is used to assume a communication which can somewhat allow retransmission more than Video.

Moreover, in a case where the communication situation of link ID=3 has returned to the state of being able to communicate data to be handled in Video, the associated TID is returned from Background to Video and resetting is performed in such a way as to be able to re-transmit streaming data.

Specifically, in this resetting, resetting for returning the state occurring after resetting illustrated in FIG. 9B to the state of initial setting illustrated in FIG. 9A is performed.

Furthermore, since resetting may be performed over and over again depending on a change in communication environment, in view of the fact that the state of initial setting illustrated in FIG. 9A is a state before the state occurring after resetting illustrated in FIG. 9B, on the basis of the state illustrated in FIG. 9B, the reading of the state illustrated in FIG. 9A can be changed as a state occurring before resetting.

Moreover, in the first exemplary embodiment, link ID=1 is made compatible with all of the TIDs, i.e., all of the categories of TIDs.

However, in response to link ID=3 being changed from Video to Background, link ID=1 can be changed in such a way as to be compatible with all of the remaining categories of TIDs excluding Background.

Alternatively, link ID=2 can be changed in such a way as to be compatible with only Video of TIDs.

This enables reducing burdens of link ID=1 and link ID=2 caused by link ID=3 having become unable to communicate data to be handled in Video.

Next, a second exemplary embodiment is described.

Even in the second exemplary embodiment, a system configuration, a hardware configuration, a sequence, and a flowchart are similar to those in the first exemplary embodiment.

The second exemplary embodiment differs from the first exemplary embodiment in that, in an allocation method for TID-to-Link Mapping, the allocation method is changed depending on whether there are two or more links each of which is able to communicate data to be handled in Video.

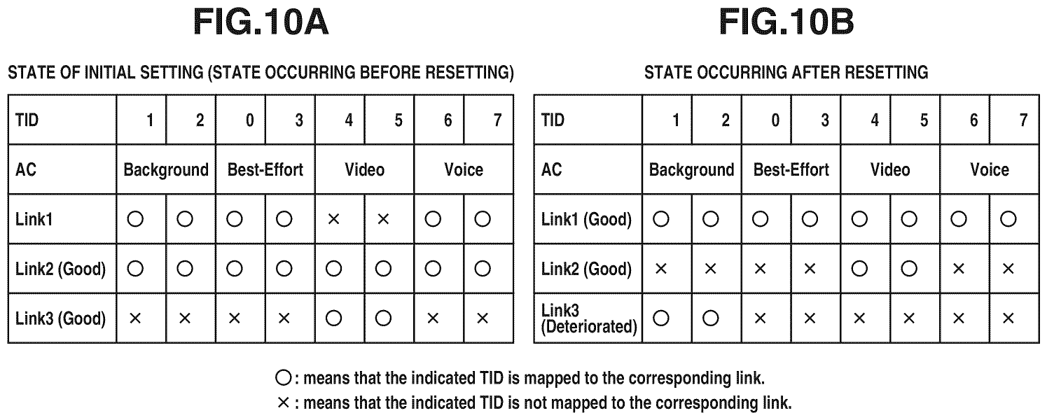

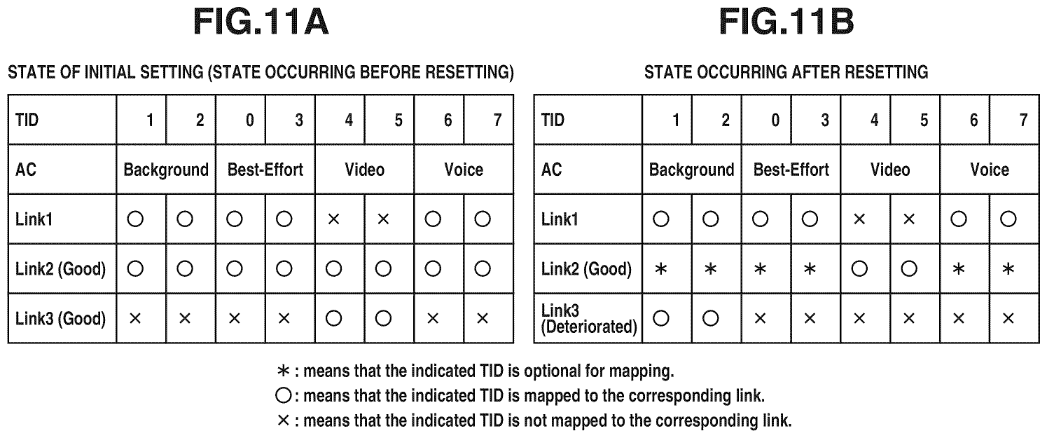

Accordingly, in the following description, the allocation method for TID-to-Link Mapping is focused on to be described with reference to FIGS. 10A and 10B and FIGS. 11A and 11B corresponding to FIGS. 9A and 9B, and issues similar to those in the first exemplary embodiment may be omitted from description.

### Example 1

First, as Example 1, a case where there are two or more links each of which is able to communicate data to be handled in Video is described.

FIGS. 10A and 10B are diagrams illustrating an example of reallocation of TID-to-Link Mapping in a case where there are two links which are good in communication state in Example 1 according to the second exemplary embodiment.

Furthermore, as mentioned above, since resetting may be performed over and over again depending on a change in communication environment, on the basis of the state occurring after resetting, the reading of the state of initial setting can be changed as a state occurring before resetting, and, in the following description, the state of initial setting is referred to as a “state occurring before resetting”.

Even in FIGS. 10A and 10B, as with FIGS. 9A and 9B, FIG. 10A illustrates an allocation state of TID-to-Link Mapping occurring before resetting, and FIG. 10B illustrates a state occurring after reallocation (resetting) of TID-to-Link Mapping.

Furthermore, even in FIGS. 10A and 10B, as always, it is assumed that the link to which link ID=1 is allocated is Link1, the link to which link ID=2 is allocated is Link2, and the link to which link ID=3 is allocated is Link3.

As illustrated in FIG. 10A, at the time of the state occurring before resetting, link ID=1 is compatible with all of the categories of TIDs excluding Video.

Moreover, link ID=2 is compatible with all of the TIDs, i.e., all of the categories of TIDs, and link ID=3 is compatible with only Video of TIDs.

Furthermore, it is assumed that the communication environment of link ID=3 in Example 1 changes to a state of being unable to communicate data to be handled in Video, as with the first exemplary embodiment.

Moreover, conversely, it is assumed that the communication environment of link ID=1 in Example 1 changes from a state of being unable to communicate data to be handled in Video to a state of being able to communicate data to be handled in Video.

Additionally, it is assumed that the communication environment of link ID=2 in Example 1 is kept good and is always in a state of being able to communicate data to be handled in Video.

In this case, with regard to a state occurring after resetting, as illustrated in FIG. 10B, link ID=3 is made incompatible with TID=4 and TID=5 for Video and is made compatible with only TID=1 and TID=2 for Background, as with the first exemplary

Moreover, link ID=1 is changed from a state of being incompatible with the category Video of TIDs to a state of being compatible with all of the TIDs, i.e., all of the categories of TIDs.

On the other hand, link ID=2 is changed from a state of being compatible with all of the TIDs, i.e., all of the categories of TIDs, to a state of being compatible with only the category Video of TIDs.

In this way, in a case where there are two or more links each of which is able to communicate data to be handled in Video, one of such two or more links is dedicated to functioning as a link exclusively used for Video.

Furthermore, while, in Example 1, the link caused to function as a link exclusively used for Video is assumed to be the link of link ID=2, a link in which the number of times of retransmission within a fixed time is smaller can be selected as a link exclusively used for Video.

Thus, if the link of link ID=1 is smaller in the number of times of retransmission within the fixed time than the link of link ID=2, the link of link ID=1 can be caused to function as a link exclusively used for Video and the link of link ID=2 can be changed to a state of being compatible with all of the categories of TIDs.

Moreover, even in Example 1, as with the first exemplary embodiment, irrespective of the state occurring before resetting and the state occurring after resetting, each value of TID is set in such a way as to be always allocated to any link, and a state in which data to be handled in a certain category of TIDs comes into a state of being unable to be transmitted in all of the links is prevented from occurring.

Thus, in order to prevent a state in which there is no link which is available for transmitting data to be handled in a given category of TIDs from occurring, setting is performed in such a manner that each category of TIDs is necessarily allocated to any link.

However, in a case where there is no link which is available for transmitting data to be handled in Video, by way of exception, TID=4 and TID=5 are not allocated to any link.

In this case, exception control for issuing a notification indicating that it is difficult to communicate data to be handled in Video or roaming control for trying to switch the connection destination to another AP can be performed.

Thus far is the description of an example of reallocation of TID-to-Link Mapping in a case where there are two or more links which are available for transmitting data to be handled in Video in Example 1 according to the second exemplary embodiment.

### Example 2

Next, as Example 2, a case where there are not two or more links which are available for transmitting data to be handled in Video is described.

FIGS. 11A and 11B are diagrams illustrating an example of reallocation of TID-to-Link Mapping in a case where there is only one link which is good in communication state in Example 2 according to the second exemplary embodiment.

Furthermore, as mentioned above, since resetting may be performed over and over again depending on a change in communication environment, on the basis of the state occurring after resetting, the reading of the state of initial setting can be changed as a state occurring before resetting, and, in the following description, the state of initial setting is referred to as a “state occurring before resetting”.

Even in FIGS. 11A and 11B, as with FIGS. 9A and 9B, FIG. 11A illustrates an allocation state of TID-to-Link Mapping occurring before resetting, and FIG. 11B illustrates a state occurring after reallocation (resetting) of TID-to-Link Mapping.

Furthermore, even in FIGS. 11A and 11B, as always, it is assumed that the link to which link ID=1 is allocated is Link1, the link to which link ID=2 is allocated is Link2, and the link to which link ID=3 is allocated is Link3.

As illustrated in FIG. 11A, at the time of the state occurring before resetting, link ID=1 is compatible with all of the categories of TIDs excluding Video.

Moreover, link ID=2 is compatible with all of the TIDs, i.e., all of the categories of TIDs, and link ID=3 is compatible with only Video of TIDs.

Furthermore, it is assumed that the communication environment of link ID=3 in Example 2 changes to a state of being unable to communicate data to be handled in Video, as with the first exemplary embodiment.

Moreover, it is assumed that the communication environment of link ID=1 in Example 2 is always in a state of being unable to transmit data to be handled in Video both before resetting and after resetting.

Additionally, it is assumed that the communication environment of link ID=2 in Example 2 is kept good and is always in a state of being able to communicate data to be handled in Video.

Then, since, as illustrated in FIG. 11B, link ID=3 comes into a state of being unable to transmit data to be handled in Video, as with Example 1, by resetting, link ID=3 is made incompatible with TID=4 and TID=5 for Video.

Moreover, as illustrated in FIG. 11B, instead, by resetting, link ID=3 is changed in such way as to be compatible with only TID=1 and TID=2 for Background.

Additionally, link ID=1 is in the same state even after resetting as that before resetting, and no change occurs between the category of TIDs with which link ID=1 is compatible before resetting and the category of TIDs with which link ID=1 is compatible after resetting.

On the other hand, link ID=2 becomes the only link which is available for transmitting data to be handled in Video, as illustrated in FIG. 11B.

In this case, link ID=2 is made compatible with only TID=4 and TID=5 for Video, thus being dedicated to communication of data to be handled in Video.

However, since, depending on situations, ink ID=2 can be made compatible with other categories of TIDs, in Example 2, the compatibility of link ID=2 is set optional with respect to the categories of TIDs other than Video.

Moreover, even in Example 2, as with the first exemplary embodiment, irrespective of the state occurring before resetting and the state occurring after resetting, each value of TID is set in such a way as to be always allocated to any link, and a state in which data to be handled in a certain category of TIDs comes into a state of being unable to be transmitted in all of the links is prevented from occurring.

Thus, in order to prevent a state in which there is no link which is available for transmitting data to be handled in a given category of TIDs from occurring, setting is performed in such a manner that each category of TIDs is necessarily allocated to any link.

However, in a case where there is no link which is available for transmitting data to be handled in Video, by way of exception, TID=4 and TID=5 are not allocated to any link.

In this case, exception control for issuing a notification indicating that it is difficult to communicate data to be handled in Video or roaming control for trying to switch the connection destination to another AP can be performed.

Thus far is the description of an example of reallocation of TID-to-Link Mapping in a case where there are not two or more links which are available for transmitting data to be handled in Video in Example 2 according to the second exemplary embodiment.

Thus, an example of reallocation of TID-to-Link Mapping in a case where there is only one link which is available for transmitting data to be handled in Video has been described.

As with the first exemplary embodiment, the second exemplary embodiment establishes Multi-Link between the image capturing apparatus 200 and the information equipment 300 and, if a link which is not in a state of being able to communicate data to be handled in Video occurs, resets TID-to-Link Mapping.

On the other hand, the second exemplary embodiment differs from the first exemplary embodiment in changing an allocation method for TID-to-Link Mapping depending on whether there are two or more links which are available for communicating data to be handled in Video.

The allocation method includes, as mentioned above, in a case where there are two or more links which are available for communication, allocating only TID=4 and TID=5 for Video to at least one or more links.

Moreover, the allocation method includes, as mentioned above, in a case where there is only one link which is available for communication, allocating TID=4 and TID=5 for Video to that link.

However, depending on situations, TIDs other than Video can be allocated.

As described above, occupying a link available for communicating data to be handled in Video as a link dedicated to Video as much as possible enables improving a communication efficiency of data to be handled in Video.

Furthermore, as mentioned above, in the description of the second exemplary embodiment, some matters similar to those in the first exemplary embodiment have been omitted from description, and, with regard to such omitted portions, the corresponding portions in the first exemplary embodiment should be referred to.

Moreover, the disclosures of the first exemplary embodiment and the second exemplary embodiment are those which sufficiently enable understanding a communication method for performing communication while establishing a plurality of links between an image capturing apparatus and opposite equipment (for example, the information equipment 300) by a Multi-Link function according to an aspect of the present disclosure.

Specifically, the communication method includes a plurality-of-links establishment step of establishing a plurality of steps (for example, the link 101, the link 102, and the link 103).

Moreover, the communication method includes a setting step of setting TID-to-Link Mapping for allocating TIDs to one or more links established in the plurality-of-links establishment step.

Additionally, the communication method includes a determination step of determining, based on states of one or more links, that the link is not in a state of being able to communicate a specific type of data corresponding to a specific category (for example, Video) of allocated TIDs.

In addition, the communication method includes a resetting step of resetting TID-to-Link Mapping in a case where, in the determination step, it is determined that the link in one or more links is not in a state of being able to communicate a specific type of data.

Specifically, in the resetting step, TID-to-Link Mapping is reset in such a way as to prevent a specific type of data from being transmitted via a link which is not adapted for communication of at least a specific type of data (for example, the link of link ID=3).

Furthermore, while, in the first exemplary embodiment and the second exemplary embodiment, a case where the image capturing apparatus 200 serving as an AP transmits a TID-to-Link Mapping Request to the information equipment 300 serving as an STA has been illustrated as an example, the transmission source of such a request in not limited to such a case.

Thus, a configuration in which an apparatus serving as an STA transmits a TID-to-Link Mapping Request to an apparatus serving as an AP can be employed.

Moreover, the disclosures of the first exemplary embodiment and the second exemplary embodiment are those which sufficiently include specific control or processing operations implementable as a program for an information communication terminal which performs communication while establishing a plurality of links between an image capturing apparatus and opposite equipment (for example, the information equipment 300) by a Multi-Link function according to an aspect of the present disclosure.

Specifically, the program includes causing an information communication terminal (for example, the image capturing apparatus 200) to perform plurality-of-links establishment processing for establishing a plurality of steps (for example, the link 101, the link 102, and the link 103).

Moreover, the program includes causing the information communication terminal to perform setting processing for setting TID-to-Link Mapping for allocating TIDs to one or more links established in the plurality-of-links establishment processing.

Additionally, the program includes causing the information communication terminal to perform determination processing for determining, based on states of one or more links, that the link is not in a state of being able to communicate a specific type of data corresponding to a specific category (for example, Video) of allocated TIDs.

Additionally, the program includes causing the information communication terminal to perform resetting processing for resetting TID-to-Link Mapping in a case where, in the determination processing, it is determined that the link in one or more links is not in a state of being able to communicate a specific type of data.

Specifically, in the resetting processing, TID-to-Link Mapping is reset in such a way as to prevent a specific type of data from being transmitted via a link which is not adapted for communication of at least a specific type of data (for example, the link of link ID=3).

Furthermore, a configuration in which a storage medium storing program code of software for implementing the above-described functions is supplied to a system or apparatus and a computer (central processing unit (CPU) or micro processing unit (MPU)) of the system or apparatus reads out and execute the program code stored in the storage medium can be employed.

In this case, the program code itself read out from the storage medium implements the functions of the above-described exemplary embodiments, and the storage medium storing the program code constitutes the above-mentioned apparatus.

Moreover, examples of a storage medium for supplying program code to be used include a flexible disc, a hard disk, an optical disc, a magneto-optical disc, a compact disc - read-only memory (CD-ROM), a CD recordable (CD-R), a magnetic tape, a non-volatile memory card, a read-only memory (ROM), and a digital versatile disc (DVD).

Additionally, not only the above-described functions can be implemented by executing program code read out by a computer, but also the above-described functions can be implemented by an OS which is running on the computer performing part or the whole of actual processing. OS is an abbreviation for operating system.

In addition, the program code read out from the storage medium can be then written into a memory included in a function expansion board inserted into the computer or a function expansion unit connected to the computer.

Then, based on an instruction of the program code, a CPU included in the function expansion board or the function expansion unit can perform part or the whole of actual processing to implement the above-described functions.

The above-described control enables performing control to efficiently use links according to a communication situation.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random access memory (RAM), a read-only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that some embodiments are not limited to the disclosed exemplary embodiments. The scope of the following claims is to be accorded the broadest interpretation so as to encompass all such modifications and equivalent structures and functions.

This application claims priority to Japanese Patent Application No. 2024-062764, which was filed on Apr. 9, 2024 and which is hereby incorporated by reference herein in its entirety.

What is claimed is:

1. A communication apparatus comprising:
at least one memory that stores a set of instructions; and
at least one processor that executes the instructions, the instructions, when executed, causing the communication apparatus to perform operations comprising:
performing control to establish a plurality of links with a different communication apparatus by a Multi-Link function;
setting TID-to-Link Mapping which allocates Traffic Identifiers (TIDs) to the established plurality of links;
performing determination processing for determining whether a link state of each of one or more links with the TIDs allocated thereto is a link state in which a communication quality needed for communicating a specific type of data corresponding to a specific category has been ensured; and
in a case where, as a result of the determination processing, it is determined that one or more links to which TIDs in the specific category are mapped are not in the link state in which the communication quality needed for communicating the specific type of data has been ensured, resetting the TID-to-Link Mapping in such a manner that the specific type of data is not transmitted via the one or more links determined not to be in the link state in which the communication quality has been ensured.

2. The communication apparatus according to claim 1, wherein the specific category is Video.

3. The communication apparatus according to claim 2,
wherein, in the determination processing, it is determined, based on a first determination condition being satisfied, that a link state of each of one or more links with the TIDs allocated thereto is not a link state in which a communication quality needed for communicating the specific type of data has been ensured, and
wherein the first determination condition is a condition in which an average number of times of retransmission of data classified into the Video which is communicated between the communication apparatus and the different communication apparatus exceeds a first upper limit value or a condition in which an average radio field intensity of a signal which is received from the different communication apparatus falls below a first lower limit value.

4. The communication apparatus according to claim 3, wherein, in a case where it is determined by the determination processing that a link state of each of the one or more links with the TIDs allocated thereto is not a link state in which a communication quality needed for communicating the specific type of data has been ensured, the resetting is performed in such a way as to prevent the Video from being included in the TIDs of the link determined not to be in the link state in which the communication quality has been ensured and in such a way as to cause Background to be included in the TIDs of the link determined not to be in the link state in which the communication quality has been ensured.

5. The communication apparatus according to claim 4,
wherein, in the determination processing, it is determined, based on a second determination condition being satisfied, that a link state of each of one or more links with the TIDs allocated thereto is a link state in which a communication quality needed for communicating the specific type of data has been ensured, and
wherein the second determination condition is a condition in which an average number of times of retransmission of data to be handled in the Background falls below a second upper limit value or a condition in which an average radio field intensity of a signal which is received from the different communication apparatus exceeds a second lower limit value.

6. The communication apparatus according to claim 5,
wherein the second upper limit value is less than or equal to the first upper limit value, and
wherein the second lower limit value is greater than or equal to the first lower limit value.

7. The communication apparatus according to claim 5, wherein, in a case where it is determined by the determination processing that a link state of each of one or more links with the TIDs in the specific category not being mapped thereto is a link state in which a communication quality needed for communicating the specific type of data has been ensured, the resetting is performed in such a manner that the TIDs in the specific category are mapped to the link determined to be in the link state in which the communication quality has been ensured.

8. The communication apparatus according to claim 1, wherein, in the resetting, resetting of the TID-to-Link Mapping is performed in such a manner that eight TIDs are mapped to at least any one of a plurality of links which is being established with the different communication apparatus.

9. The communication apparatus according to claim 2, wherein, in the resetting, in a case where there are two or more links the link state of each of which is a link state in which a communication quality needed for communicating the specific type of data has been ensured, resetting of the TID-to-Link Mapping is performed in such a manner that TID corresponding to the Video are mapped to and other TIDs not corresponding to the Video are not mapped to at least one or more links out of the two or more links.

10. The communication apparatus according to claim 1, wherein, in the resetting, resetting of the TID-to-Link Mapping is performed by transmitting, to the different communication apparatus, a TID-to-Link Mapping Request frame including a TID-to-Link Mapping Element configured in such a manner that TIDs in the specific category are not mapped to at least a link which is in a link state in which a communication quality needed for communicating the specific type of data has not been ensured and receiving, from the different communication apparatus, a TID-to-Link Mapping Response frame including information indicative of Success.

11. A control method for a communication apparatus, the control method comprising:
establishing a plurality of links with a different communication apparatus by a Multi-Link function;
setting TID-to-Link Mapping which allocates Traffic Identifiers (TIDs) to the established plurality of links;
performing determination processing for determining whether a link state of each of one or more links with the TIDs allocated thereto is a link state in which a communication quality needed for communicating a specific type of data corresponding to a specific category has been ensured; and
in a case where, as a result of the determination processing, it is determined that one or more links to which TIDs in the specific category are mapped are not in the link state in which the communication quality has been ensured, resetting the TID-to-Link Mapping in such a manner that the specific type of data is not transmitted via the one or more links determined not to be in the link state in which the communication quality has been ensured.

12. A non-transitory computer-readable storage medium storing computer-executable instructions for causing a computer to perform a method for controlling a communication apparatus, the method comprising:
establishing a plurality of links with a different communication apparatus by a Multi-Link function;
setting TID-to-Link Mapping which allocates Traffic Identifiers (TIDs) to the established plurality of links;
performing determination processing for determining whether a link state of each of one or more links with the TIDs allocated thereto is a link state in which a communication quality needed for communicating a specific type of data corresponding to a specific category has been ensured; and
in a case where, as a result of the determination processing, it is determined that one or more links to which TIDs in the specific category are mapped are not in the link state in which the communication quality has been ensured, resetting the TID-to-Link Mapping in such a manner that the specific type of data is not transmitted via the one or more links determined not to be in the link state in which the communication quality has been ensured.
